(19) United States
(12) Patent Application Publication
(10) Pub. No.: US 2007/0048073 A1
(43) Pub. Date: Mar. 1, 2007

(54) Ring binder having a clip

(76) Inventors: Hung Yu Cheng, Hong Kong (CN); John Joseph Bittner, Bur Ridge, IL (US)

Correspondence Address: SENNIGER POWERS, ONE METROPOLITAN SQUARE, 16TH FLOOR, ST LOUIS, MO, 63102, US

(21) Appl. No.: 11/215,948

(22) Filed: Aug. 31, 2005

(51) Int. Cl. B42F 3/00

(52) U.S. Cl. 402/70

(57) ABSTRACT

A ring binder mechanism comprises a housing, at least one ring supported by the housing for mounting loose leaf paper, and at least one connector member extending outwardly from the housing. At least one clip secures the connector member to a substrate. The clip is sized and shaped to slide onto the substrate and engage the connector member for securing the clip to the substrate and securing the connector member to the substrate.

### BACKGROUND OF THE INVENTION

This invention relates to ring binders for retaining loose-leaf pages, and in particular to a clip for attaching a ring binder mechanism to a cover to form the ring binder.

Conventional ring binders are made by securing a ring binder mechanism to a cover using rivets. Commonly, ring binder mechanisms include a housing and a plurality of ring members attached to the housing for retaining loose-leaf pages, such as hole-punched pages. Typically, the ring binder mechanism is secured to the cover by inserting the rivets through the cover and openings in the ring binder mechanism. The tail of each of the rivets is then deformed (e.g., by punching) to engage and fasten the ring binder mechanism. Once assembled, the ring binder is packaged and shipped to a distributor, a retailer, or directly to an end user (i.e., consumer).

One of the drawbacks of traditional ring binders relates to their shipping and storage after they are assembled. When assembled, large gaps exist between the ring binder mechanism and the cover for each ring binder leaving large amounts of room unused during shipping and storing of multiple ring binders. Thus, the number of ring binders in each package is greatly limited. As a result, packaging and shipping conventional ring binders is inefficient which results in significant shipping and handling costs. Moreover, even a limited number of ring binders occupy a substantial amount of storage space or retail display space.

In response to this drawback, manufacturers of ring binders typically pack the mechanisms in alternating directions. But even this packing technique leaves large amounts of unused space. Further efforts to overcome some of the short comings of conventional ring binders have been disclosed in coassigned U.S. Pat. No. 5,924,811 to To et al., U.S. Pat. No. 5,879,097 to Cheng, and U.S. Pat. No. 5,160,209 to Schuessler, all of which are hereby incorporated by reference in their entireties.

### SUMMARY OF THE INVENTION

In general, a ring binder mechanism of the present invention generally comprises a housing, at least one ring supported by the housing for mounting loose leaf paper, and at least one connector member extending outwardly from the housing. At least one clip secures the connector member to a substrate. The clip is sized and shaped to slide onto the substrate and engage the connector member for securing the clip to the substrate and securing the connector member to the substrate.

In another aspect, a ring binder of the present invention generally comprises a ring binder mechanism including a housing having at least one ring for mounting loose leaf paper and at least two connector members extending outwardly from the housing. A cover includes a front panel, a back panel and a spine. The front and back panels are hingedly attached to the spine so that the panels are movable to selectively cover or expose loose leaf pages retained by the ring binder mechanism. A clip secures each of the connector members to the cover. Each clip extends around a respective edge of the cover and engages a respective one of the connector members for securing the connector member to the cover.

In yet another aspect, the present invention is directed to a method of attaching a ring binder mechanism to a cover. The ring binder mechanism comprises at least one ring for mounting loose leaf paper thereon and at least one connector member extending outwardly from the housing. The method generally comprises arranging the ring binder mechanism and cover together in a predetermined orientation. A clip is slide onto an edge of the cover so that the clip engages the connector member and cover and secures the connector member and ring binder mechanism to the cover.

Other objects and features of the present invention will be in part apparent and in part pointed out hereinafter.

### BRIEF DESCRIPTION OF THE DRAWINGS

FIG. 1 is a perspective of a ring binder including a cover and a ring binder mechanism attached to the cover using a clip of the present invention;

FIG. 2 is the perspective of FIG. 1 with the ring binder mechanism exploded from a back panel of the cover, a spine and front panel of the cover being removed;

FIG. 3 is a perspective similar to the one shown in FIG. 2 except the ring binder mechanism is shown engaging the back panel of the cover;

FIG. 4 is a section taken on line 4-4 of FIG. 1;

FIG. 5 is a bottom side perspective of the ring binder mechanism;

FIG. 6 is an exploded perspective of the ring binder mechanism;

FIG. 7 is the perspective of FIG. 5 but with the ring members in an open position;

FIG. 8A is an enlarged fragmentary perspective of the ring binder mechanism with a housing removed and showing a lever connected to hinge plates;

FIG. 8B is a section taken on line 8B-8B of FIG. 8A;

FIG. 9 is an enlarged, top side perspective of the clip;

FIG. 10 is a fragmentary perspective of the ring binder mechanism engaging the cover with the clip contacting an edge of the cover;

FIG. 11 is a fragmentary perspective similar to FIG. 10 except the clip is received on the cover and secures the ring binder mechanism to the cover;

FIG. 12 is a section taken on line 12-12 of FIG. 11;

FIG. 13 is a perspective of a clip having another configuration;

FIG. 14 is a fragmentary perspective similar to FIG. 11, but showing the clip of the FIG. 13 configuration;

FIG. 15 is a section taken on line 15-15 of FIG. 14;

FIG. 16 is a perspective of a clip having yet another configuration;

FIG. 17 is a fragmentary perspective similar to FIG. 11, but showing the clip of the FIG. 16 configuration;

FIG. 18 is a section taken on line 18-18 of FIG. 17;

FIG. 19 is a perspective of a clip having still another configuration, part of the clip being broken away;

FIG. 20 is a fragmentary perspective showing the clip of the FIG. 19 configuration being slid onto a cover;

FIG. 21 is a section taken on line 21-21 of FIG. 20;

FIG. 22 is a fragmentary perspective similar to FIG. 11, but showing the clip of the FIG. 19 configuration;

FIG. 23 is a section taken on line 23-23 of FIG. 21;

FIG. 24 is a bottom side perspective of a ring binder mechanism having another configuration;

FIG. 25 is a fragmentary perspective similar to FIG. 11, but showing a ring binder mechanism of FIG. 24; and

FIG. 26 is a section taken on line 26-26 of FIG. 25.

Corresponding reference characters indicate corresponding parts throughout the drawings.

### DETAILED DESCRIPTION OF THE INVENTION

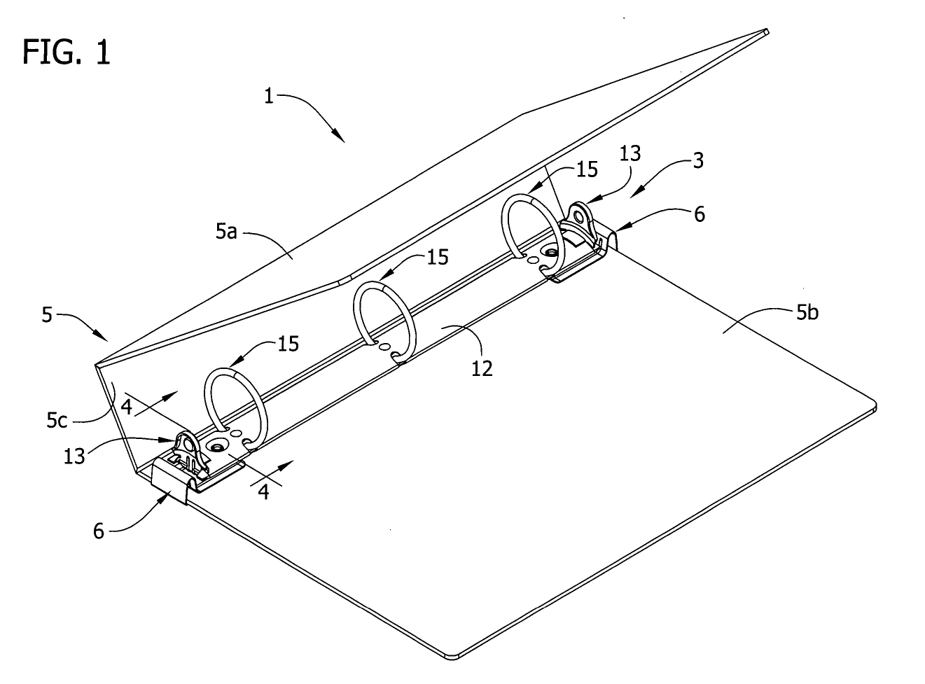

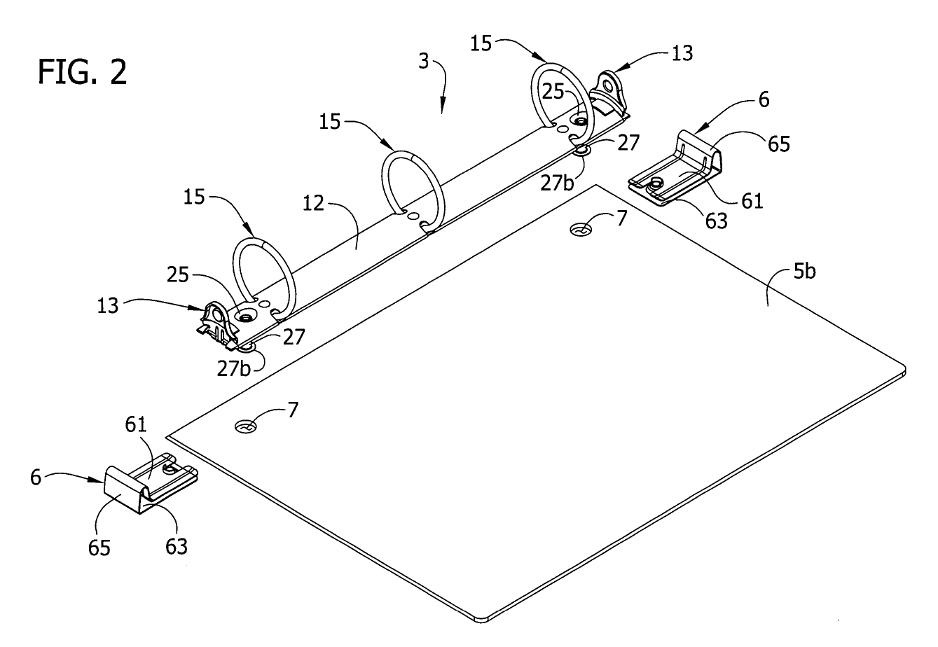

Referring now to the drawings, and particularly to FIGS. 1 and 2, a ring binder according to the present invention is designated generally by reference numeral 1. The ring binder 1 comprises a ring binder mechanism 3 affixed on a cover 5 (broadly, “a substrate”) using a clip 6 of the present invention. The cover, ring binder mechanism, and clip are indicated generally by their respective reference numbers. The cover 5 includes a front panel 5a, a back panel 5b, and a spine 5c. The front and back panels 5a, 5b are hingedly attached to the spine 5c so that they are movable to selectively cover or expose loose leaf pages (not shown) retained by the ring binder mechanism 3. As shown in FIG. 2 , the back panel 5b of the cover 5 includes two apertures 7. One of the apertures 7 is located generally adjacent one edge of the back panel 5b and the other aperture is located generally adjacent an opposite edge of the back panel. The number of apertures 7 may be other than two and be within the scope of the present invention. While the ring binder mechanism 3 is shown affixed on the back panel 5b of the cover 5, it is understood that the ring binder mechanism 3 can be affixed on the front panel 5a or the spine 5c of the cover 5. Moreover, the ring binder mechanism 3 can be mounted on substrates other than the cover 5, such as files, without departing from the scope of the present invention.

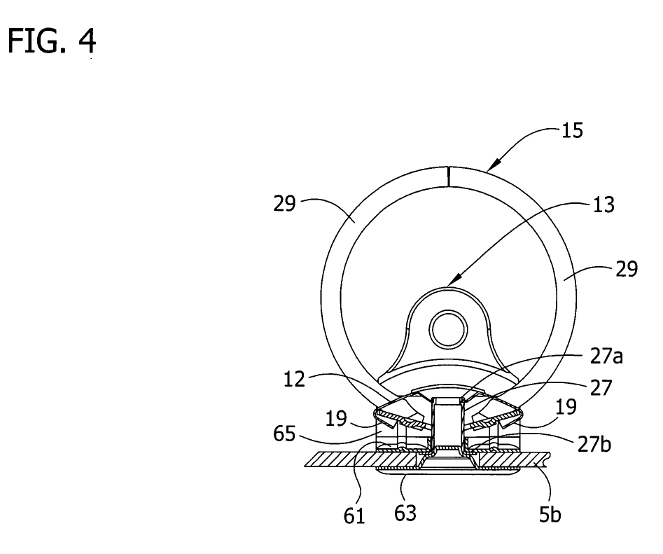

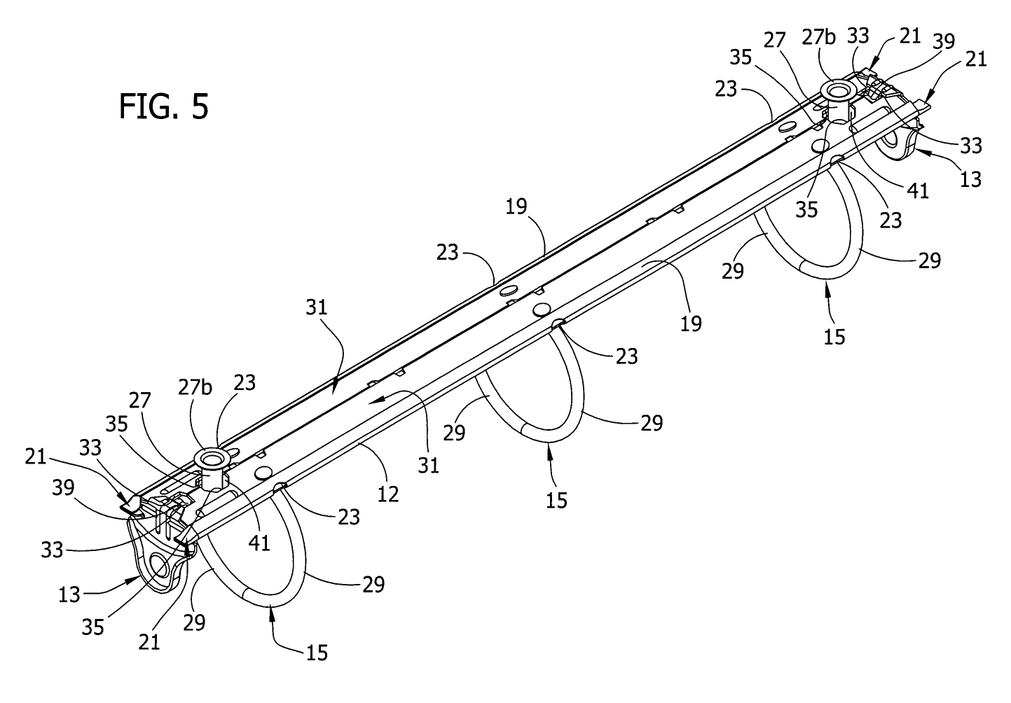

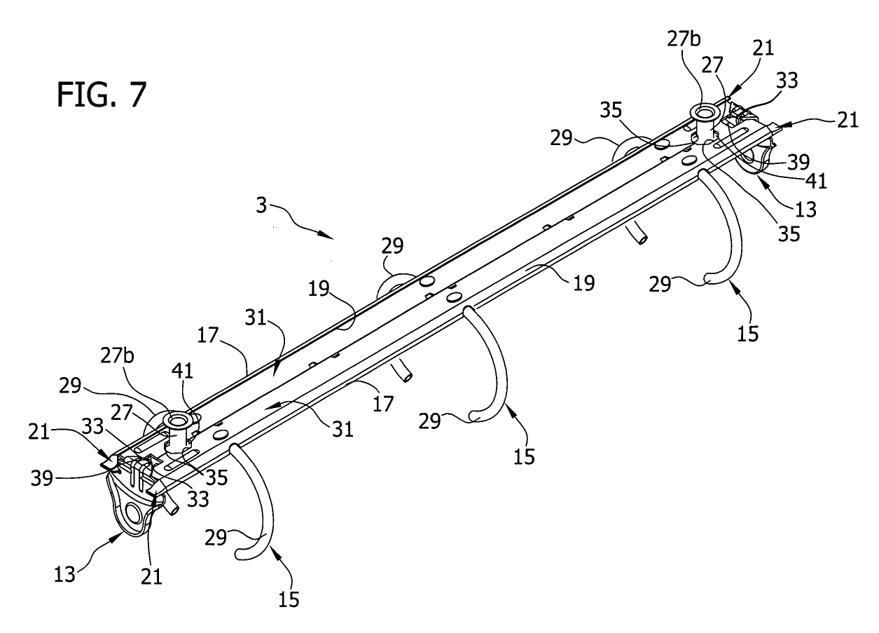

As shown in FIGS. 1-4, the ring binder mechanism 3 includes an elongate housing 12 that supports two substantially similar actuating levers (each designated generally by reference numeral 13) and three rings (each designated generally by reference numeral 15). The housing 12 is symmetrical with a roughly arch-shaped cross section (see FIG. 4) and includes a longitudinal axis, two transversely opposite longitudinally extending edges, and two longitudinal ends (see FIG. 2). Each lever 13 pivotally mounts on the housing 12, generally at an opposite longitudinal end, for controlling movement of the rings 15 between a closed position (see FIG. 5) and an open position (see FIG. 7).

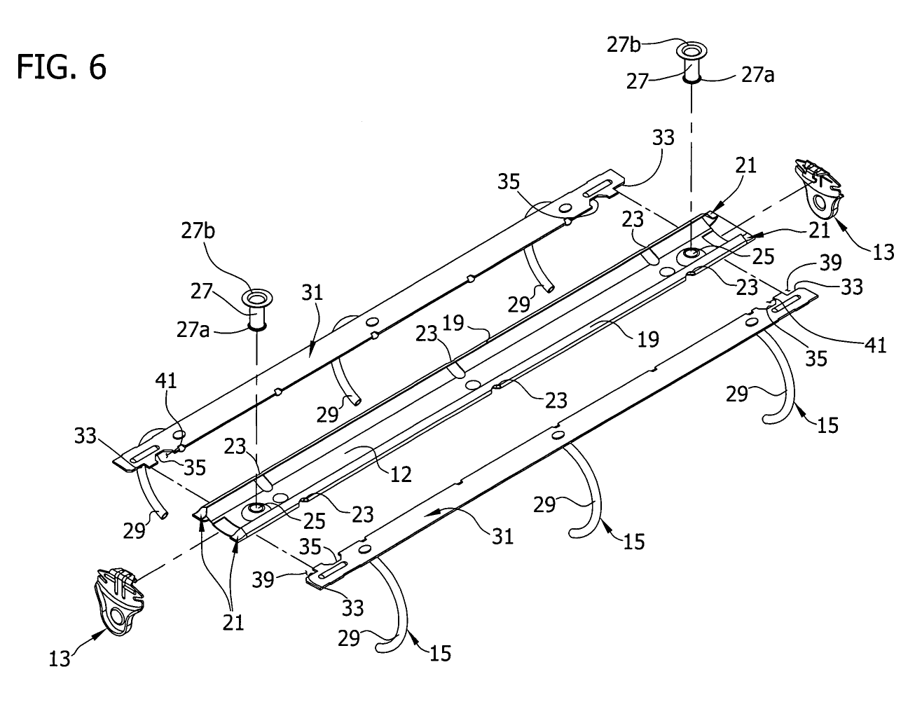

As best shown in FIGS. 5 and 6, a bent under rim 19 formed along each longitudinal edge of the housing 12 extends the full length of the housing from one longitudinal end to the other. Each end of the two bent under rims 19 is pinched together with a portion of an upper surface of the housing 12 to form four pockets (each pocket being designated by reference numeral 21). Accordingly, there are two pockets 21 located at each end of the housing 12. Six total slots 23 are positioned along the two bent under rims 19. The slots 23 are arranged in three transversely opposed pairs with each pair receiving one of the rings 15 therethrough, allowing each ring to move laterally of the housing 12 for opening and closing. As shown in FIG. 5, two additional circular openings 25 are provided in the upper surface of the housing 12, near the longitudinal ends, each receiving and attaching mounting posts 27 (broadly, “connector members”) to the housing 12. It is envisioned that the housing of the present invention is made of metal, but it may be made of any other suitable material that is sufficiently rigid to provide a stable mount for components of the mechanism. In addition, differently shaped housings, including asymmetrical ones, do not depart from the scope of this invention.

Each of the rings 15 include two ring members 29, which are supported by the housing 12 for movement relative to one another between a closed position (see FIG. 5) and an open position (see FIG. 7). In the closed position, the ring members 29 form a substantially continuous, closed, ring or loop for retaining loose-leaf pages and for allowing the pages to move along the rings 15 from one ring member 29 to the other. In the open position, the ring members 29 form a discontinuous, open loop suitable for adding or removing pages. It is envisioned that the ring members are formed of a conventional, cylindrical rod of suitable material, such as steel. But it is understood that ring members having a different cross section or ring members made of different material do not depart from the scope of the present invention. Although in the illustrated mechanism both ring members can move, mechanisms having one movable ring member and one fixed do not depart from the scope of the invention. In addition, mechanisms with greater or fewer than three rings or with rings that form other shapes, such as slanted “D” shapes, when ring members are closed, do not depart from the scope of this invention.

As shown in FIGS. 5-7, the two ring members 29 of each ring 15 are mounted opposite each other on one of a pair of hinge plates (each hinge plate being designated generally by reference numeral 31). The hinge plates 31 are each thin and elongate, having an inner and an outer longitudinal edge margin and two longitudinal ends. Each hinge plate 31 additionally includes two squared notches 33 and two rounded cutouts 35, each of which are located along the inner longitudinal edge margin of the hinge plate. The two notches 33 are each located at a respective longitudinal end of the hinge plate 31, and the two cutouts 35 are each located inward from a one of the respective notches 33 but still generally adjacent the hinge plate's ends.

Referring again to FIGS. 5 and 7, the hinge plates 31 attach to one another in parallel arrangement along their inner longitudinal edge margins, forming a central hinge having a pivot axis. The housing 12 loosely receives the outer longitudinal edge margins of the interconnected hinge plates 31 above its two bent under rims 19. Thus, the hinge plates 31 are retained on the housing 12 while the outer longitudinal edge margins are free to move within the rims 19. Corresponding notches 33 of the adjoining hinge plates align to form two box-shaped recesses 39 at opposite longitudinal ends of the plates 31. These recesses 39 are sized and shaped to interact with the actuating levers 13, as will be described in more detail hereinafter. Similarly, corresponding cutouts 35 align to form two openings 41, each sized and shaped for receiving one of the mounting posts 27 through the hinge plates 31. In the illustrated ring binder mechanism the box-shaped recesses 39 and the oval openings 41 are both symmetrically positioned about the pivot axis of the interconnected hinge plates 31. However, mechanisms in which openings and recesses are positioned differently about a pivot axis of interconnected hinge plates do not depart from the scope of the present invention.

The housing 12 is slightly narrower than the joined hinge plates 31 when the hinge plates are in a coplanar position (i.e., an angle between exterior surfaces of the hinge plates is 180°). So as the hinge plates 31 pivot through this position, they deform the resilient housing 12 and cause a spring force in the housing that urges the hinge plates 31 to pivot away from the coplanar position, either closing the ring members 29 (i.e., moving the pivot axis down and away from the housing's upper surface (FIG. 5)) or opening them (i.e., moving the pivot axis up and toward the housing's upper surface (FIG. 7)). Moreover, when the ring members 29 are closed, this spring force resists hinge plate movement and clips the ring members together. When the ring members 29 are open, the spring force holds them apart. Thus, the illustrated embodiment uses a conventional arrangement to move the hinge plates 31 and ring members 29. It will be understood that other ways of moving the rings members 29 and locking them in a closed position or open position may be used within the scope of the present invention.

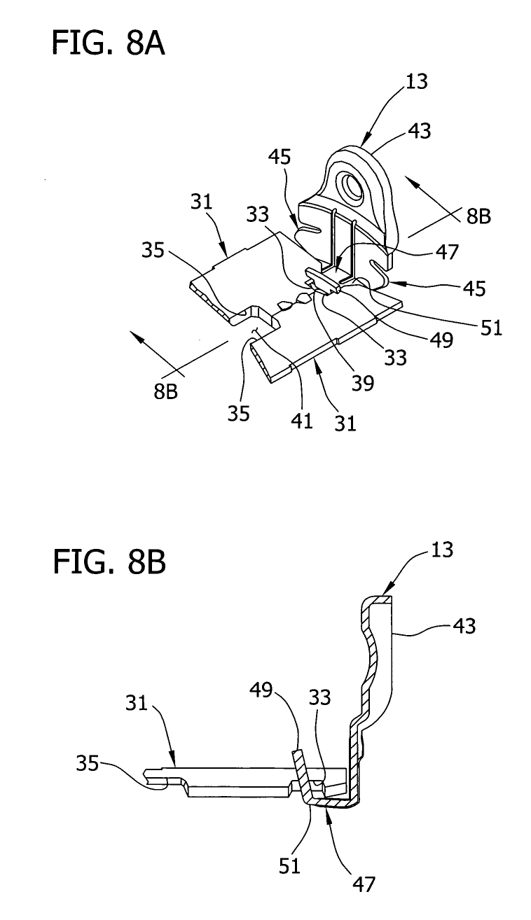

The two actuating levers 13 are generally shown in FIGS. 1-3, 8A and 8B. Each lever 13 includes a relatively flat head 43 that extends upward, generally above the housing 12, for grasping to pivot the lever. Each additionally includes two lateral arms, each designated by reference numeral 45, and a cam, designated generally by reference numeral 47. As best shown in FIG. 8A, the lateral arms 45 extend laterally outward from opposite sides of each lever 13 below the flat head 43. The two arms 45 of each lever loosely fit within the two pockets 21 located at each longitudinal end of the housing 12, allowing the levers 13 to pivot within the pockets 21 relative to the housing about an axis transverse to the housing (FIGS. 5 and 7). Referring again to FIGS. 8A and 8B, the cam 47 of each lever is integrally attached to the lever 13 below the lateral arms 45. It extends downward from the arms 45 and curves outward from the flat head 43, fitting into one of the respective box-shaped recesses 39 of the hinge plates. An enlarged tab 49 of each cam fits loosely over the interconnected hinge plates 31 while a base 51 of each cam rests below the plates. Together, the tab 49 and base 51 capture the hinge plates 31 therebetween for operable engagement to control the pivoting motion of the hinge plates that close and open the ring members 29. In operation to close the ring members 29, the levers 13 are pivoted upward and inward. The tabs 49 engage a top surface of the hinge plates 31 and pull the pivot axis of the plates downward. To open the ring members 29, the levers 13 are pivoted outward and downward. The bases 51 engage a bottom surface of the hinge plates 31 and push the pivot axis of the plates upward. Mechanisms (not shown) having levers with different shapes or levers pivotally attached to a housing differently do not depart from the scope of the present invention. In addition, mechanisms having only one lever for driving the hinge plates do not depart from the scope of the present invention.

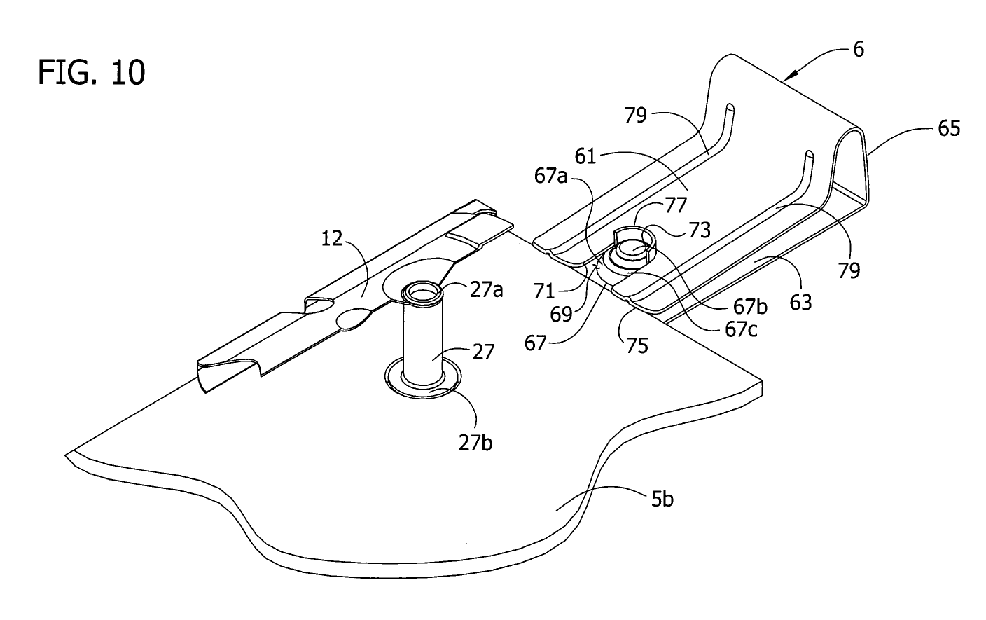

Referring again to FIGS. 5-7, the two mounting posts 27 are located adjacent the levers 13 and space the ring binder mechanism 3 off the cover 5 so that the hinge plates 31 can pivot without engaging the back panel 5b of the cover. In this position, the mounting posts 27 align with the oval openings 41 of the interconnected hinge plates 31 and pass through the hinge plates without interfering with their operation. Each mounting post 27 includes a tubular body defining an interior space and two open longitudinal ends. A first end includes a deformable lip 27a for attaching the mounting post to one of the circular openings 25 in the upper surface of the housing 12 (FIG. 10). It will be understood that other ways of attaching the mounting posts 27 to the housing 12 may be used without departing from the scope of the present invention. Referring again to FIGS. 5-7, a second end includes a flange 27b that extends outwardly from the mounting post 27. The flange can have other shapes and configurations without departing from the scope of this invention.

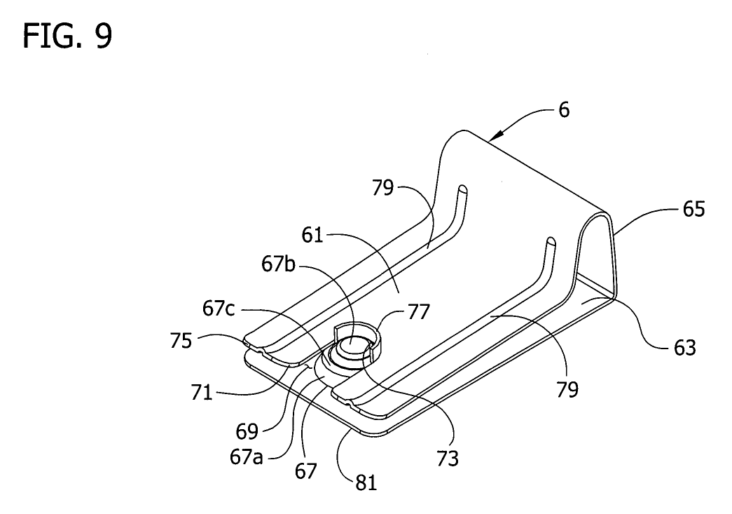

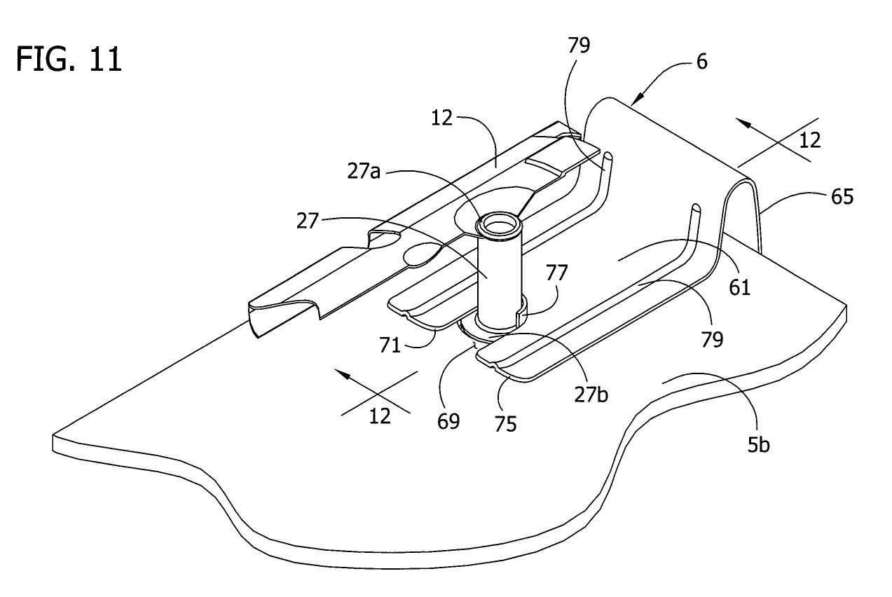

As illustrated in FIGS. 1-3, the ring binder mechanism 3 is securely attached to the back panel 5b of the cover 5 using two clips 6. The clips 6 are sized and shaped to slide onto the back panel 5b of the cover 5 and engage respective mounting posts 27 for securing both the clips and the mounting posts to the back panel. Since the clips 6 are substantially identical, only one will be described in detail. The use of two differently configured clips with the same ring binder mechanism and cover would not depart from the scope of the present invention. The clip 6, as shown in FIGS. 9-12, comprises a first portion 61, a second portion 63, and an intermediate portion 65 connecting the upper and second portions. The first and second portions 61, 63 are resiliently biased toward one another so that when the clip 6 is received on the back panel 5b of the cover 5 the clip can secure the mounting post 27 and thereby the ring binder mechanism 3 to the cover. In other words, the first and second portion 61, 63 are adapted to squeeze the mounting post 27 and the cover 5 together. The first and second portions 61, 63 define generally flat opposing surfaces that lie generally in parallel planes. The spacing between the surfaces of the upper and second portions 61, 63 is slightly less than the thickness of the cover 5. The clip 6 of the illustrated configuration is formed from a single-piece of generally flat sheet metal. But it is understood that the clip 6 can be formed from more than one piece without departing from the scope of this invention.

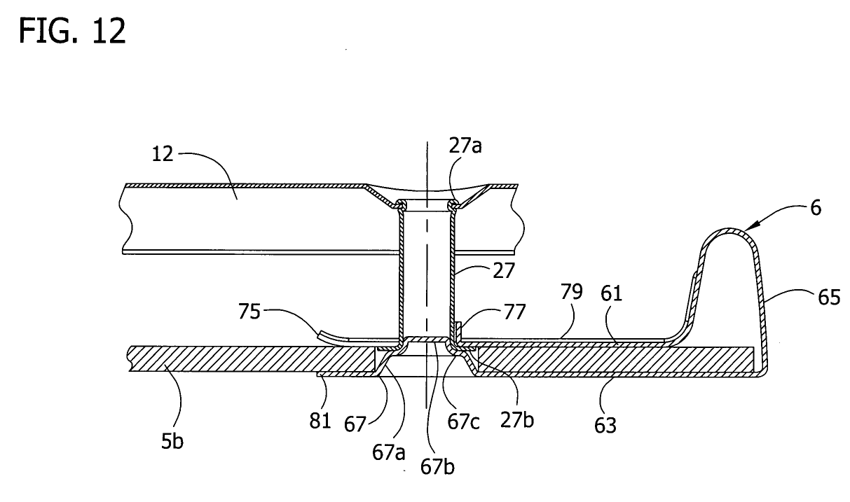

The second portion 63 is formed with a seat for receiving the flange 27b of one of the mounting posts 27. The seat comprises a generally conical nub 67 extending upwardly from the second portion. As best shown in FIG. 12, the nub 67 includes a base portion 67a, a top potion 67b, and a shelf 67c separating the base and top portions. When engaged with the mounting post 27, the flange 27b of the mounting post 27 rests on the shelf 67c and the top portion 67b extends partially into the interior space of the mounting posts. When the clip 6 is attached to the cover 5, the nub 67 is received in one of the apertures 7 in the cover and the most of the remainder of the second portion 63 is in face-to-face relationship with an exterior surface of the cover.

The first portion 61 includes a slot 69 having an open end 71 and a closed bottom end 73. The slot 69 is sized and shaped for receiving one of the mounting posts 27 and extends from a free outer edge 75 of the first portion to slightly past the top 67b of the nub 67 so that the flange 27b on the mounting post can be engaged with the nub. A reinforcing ridge 77 is positioned adjacent the closed bottom end 73 of the slot 69 for engaging the mounting post 27 when the clip 6 is positioned on the cover 5. The first portion 61 is bent slightly upward away from the second portion 63 adjacent the outer free edge 75 for allowing the clip 6 to slide more easily onto the cover 5 as described in move detail below. The first portion 61 also includes two elongate ribs 79 extend generally lengthwise of the first portion on opposite sides of the slot 69 to strengthen the first portion against bending about an axis transverse to the first portion of the clip 6. When the clip 6 is positioned on the cover 5, the surface of the first portion 61 is in face-to-face relationship with an interior surface of the cover.

The intermediate portion 65 yieldably and resiliently resists movement of the first and second portions 61, 63 with respect to one another to prevent the clip 6 from inadvertently disengaging the mounting post 27 and/or cover 5. In the illustrated configuration, the intermediate portion 65 extends from the second portion 63 past the plane of the first portion 61 and thence back to the first portion. As a result, the intermediate portion 65 defines a grip projecting up from the first portion 61 for gripping the clip. The grip makes it easier for a user to engage and disengage the clip from the cover. Morever, when the clip 6 is positioned on the cover 5, the intermediate portion 65 provides a guard protecting a user's fingers from the ends of the ring binder, which may potentially have sharp edges. In addition, the intermediate portion 65 covers and protects a portion of an edge of the cover 5. It is understood that in other configurations of the clip 6, the intermediate portion can connect the first and second portions 61, 63 without extending beyond the plane of the first portion.

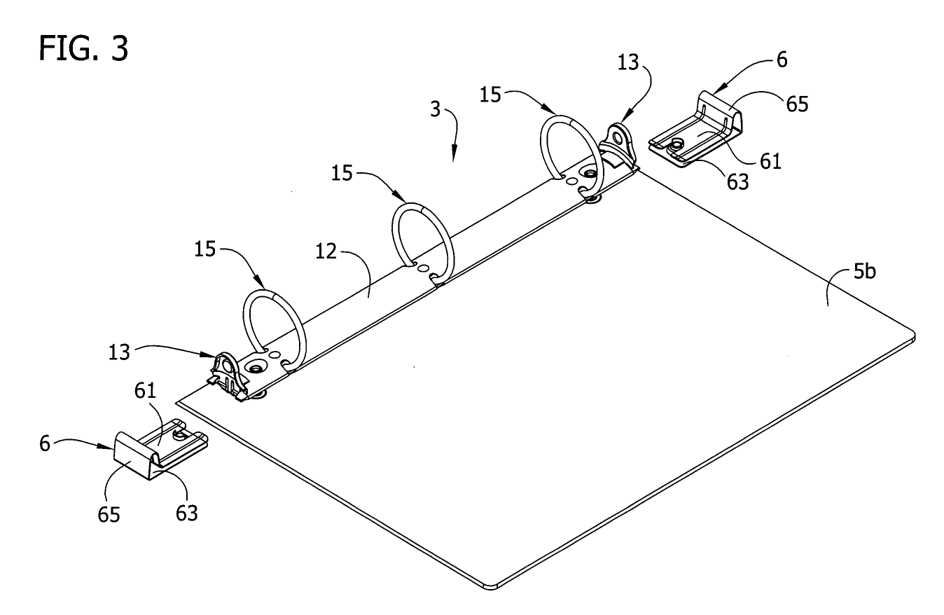

The ring binder 1 of the illustrated embodiment can be assembled by aligning the ring binder mechanism 3 with respect to the cover 5 so that the flanges 27b of the mounting posts 27 are received in the apertures 7 in the back panel 5b of the cover 5 (FIGS. 3 and 10). The clips 6 are slid onto the cover 5 one at a time. Since both clips 6 are attached to the cover 5 in the same way, only one is described herein. The free outer edge 75 of the first portion 61 of the clip 6 is placed against an upper edge of the cover and a free outer edge 81 of the second portion 63 is placed against a lower edge of the cover. The clip 6 is pushed toward the ring binder mechanism 3 so that the first portion 61 slides over the interior surface of the cover 5 and the second portion 63 sides over the exterior surface of the cover. The bent surface at the outer free edge 75 of the first portion 61 acts as an inclined surface and facilities sliding the clip 6 onto the cover 5 by wedging the first and second portions apart. As the clip 6 slides on the cover 5, the second portion 63 pivots about the intermediate portion 65 and deflects away from the first portion 61 to allow the nub 67 to slide along the exterior surface of the cover. The slot 69 receives the mounting post 27 into engagement with the ridge 77 at the closed bottom end 73 of the slot. The nub 67 eventually moves into registration with the aperture 7 and the resiliency of the clip 6 causes the nub to snap into the aperture.

Referring to FIGS. 1, 11, and 12, once in place the clip 6 secures the ring binder mechanism 3 to the cover 5. The nub 67 of the second portion 63 is received in the aperture 7 of the cover 5 to inhibit axial movement of the clip. The flange 27a of the mounting post 27 is received on the shelf 67c of the nub 67 and the top portion 67a of the nub is received in the interior space of the mounting post. The first portion 61 cooperates with the shelf 67c of the nub 67 to securely hold the flange 27a of the mounting post 27. Another clip can be secured to the other mounting post in the same way. Once both clips 6 are in place, the ring binder mechanism 3 is securely affixed to the cover 5.

The ring binder mechanism 3 can be separated from the cover 5 by disengaging both clips 6 from the ring binder mechanism and the cover. One way to remove one of the clips 6 from the ring binder mechanism 3 and the cover 5 is to deflect the second portion 63 of the clip 6 a sufficient amount to allow the nub 67 to clear the aperture 7 in the cover 5. The second portion 63 can be deflected either manually or with a tool (not shown). Once the nub 67 is deflected beyond the aperture 7, the clip 6 can be slid off the cover 5. The clip 6 can also be removed by grasping the intermediate portion 65 of the clip 6 and pulling the clip longitudinally away from the ring binder mechanism 3 and the cover 5. The sloped sides of the nub 67 slide along the edge of the respective aperture 7 in the cover 5 causing the first and second portions 61, 63 of the clip 6 to deflect away from each other as the clip is pulled off the cover and away from the mounting post 27 of the ring binder mechanism. Once both clips 6 have been removed, the ring binder mechanism 3 can be easily separated from the cover 5 by removing the flanges 27b of the mounting posts 27 from the apertures 7 in the cover.

Accordingly, ring binders 1 of the present invention can be packaged, shipped, stored and/or sold without having the ring binder mechanism 3 attached to the cover 5. For example, the covers 5 can be packaged such that little space between adjacent covers is wasted. This can be done by lying the covers 5 flat such that the front panel 5a, back panel 5b, and spine 5c are all substantially in the same plane and stacking others on top. The ring binder mechanisms 3 can be packaged in the same container as the covers 5 or separately. Either way, the ring binder mechanism 3 can be arranged to minimize wasted space. One possible packing arrangement for the ring binder mechanisms 3 is to pack them in alternating directions such that the rings 15 of one mechanism are positioned between the rings of an adjacent mechanism. The clips 6 can be packaged with the cover 5, the ring binder mechanisms 3 or in a separate container. The separated covers 5 and ring binder mechanisms 3 can be packaged, shipped, and stored more efficiently and cost effectively than covers having the ring binder mechanisms attached.

The ring binder mechanism 3 and covers 5 can be attached, for example, by the retailer prior to transferring them to a customer (i.e, after a sale) or before placing them on display. It is also understood that the customer may wish to maintain the ring binder mechanism 3 and covers 5 separately to take advantage of the saved storage space. Thus, the customer may be the one who attaches the ring binder mechanism 3 to the cover 5. Accordingly, it is understood that the ring binder mechanism 3 and cover 5 of the present invention can be joined to form a ring binder 1 at any of various times. The examples of the ring binder mechanism 3 being attached to the cover 5 by a retailer and an end user are exemplary only as it is understood that other individuals, including the ring binder manufacturer, may assemble the ring binder. It is also understood that the ring binder mechanism could be attached to the cover using an automated process as well as the manual process described herein.

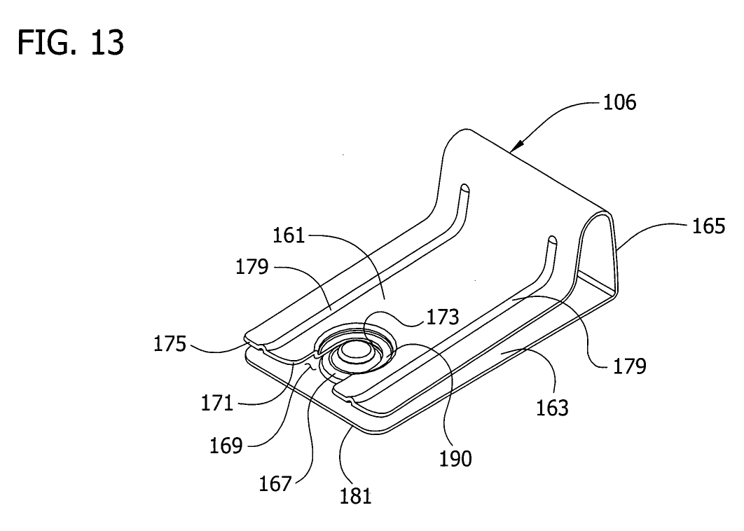

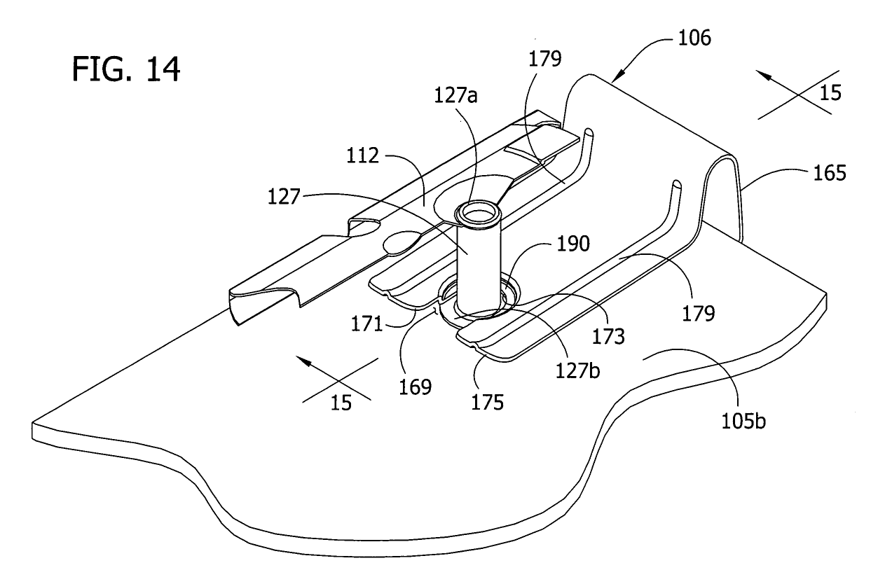

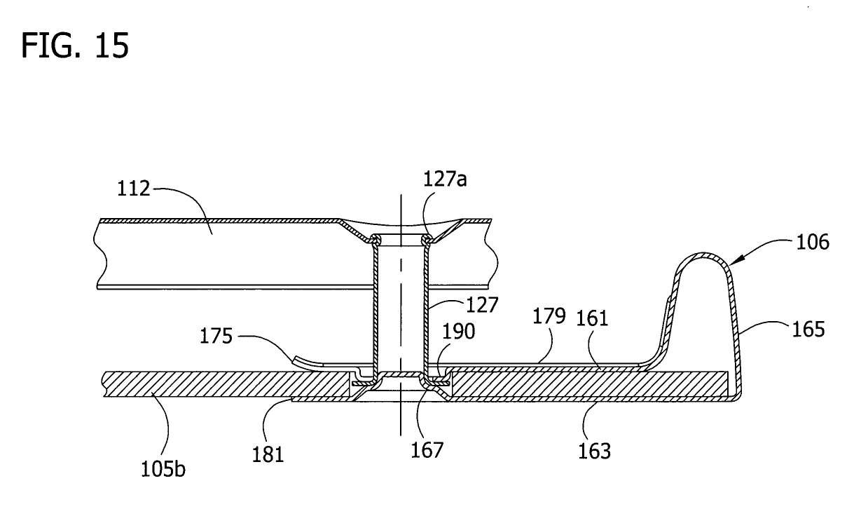

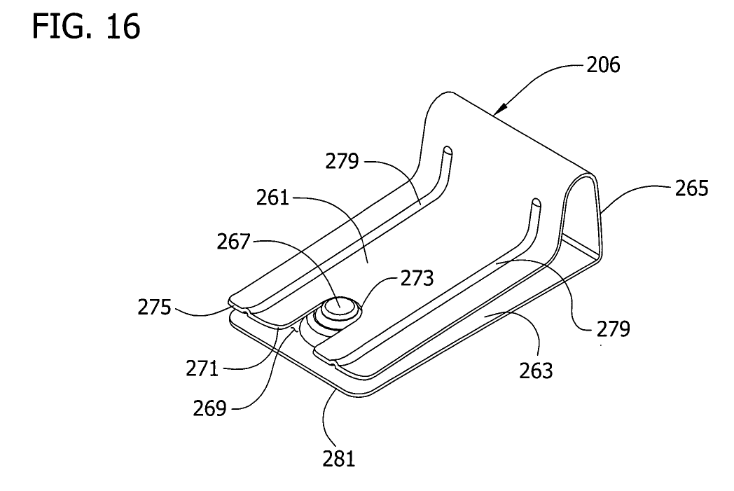

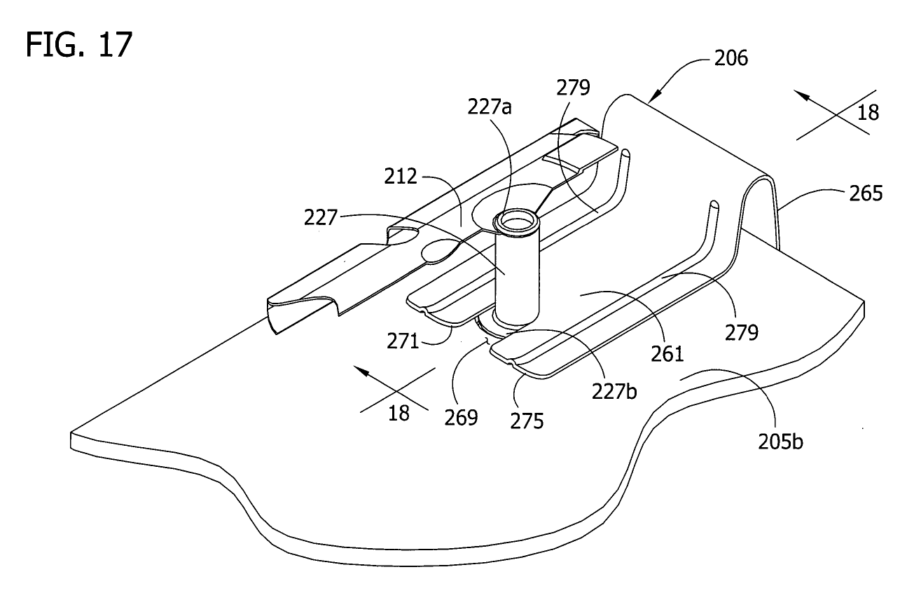

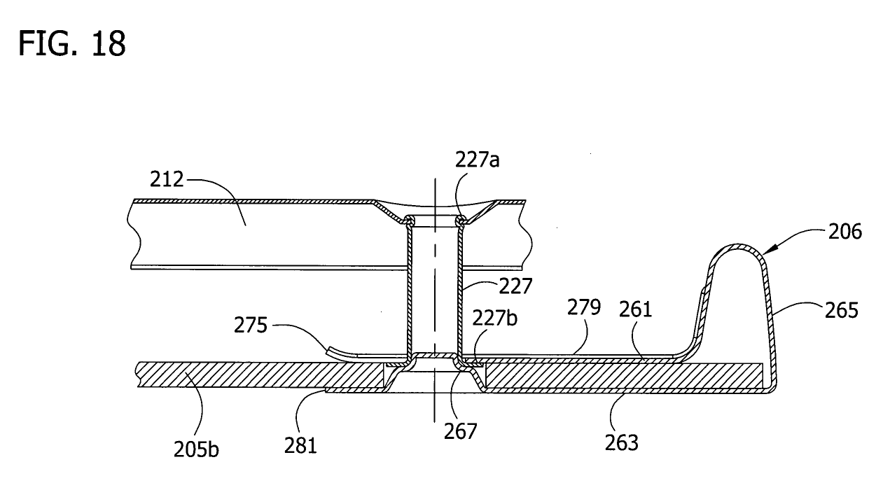

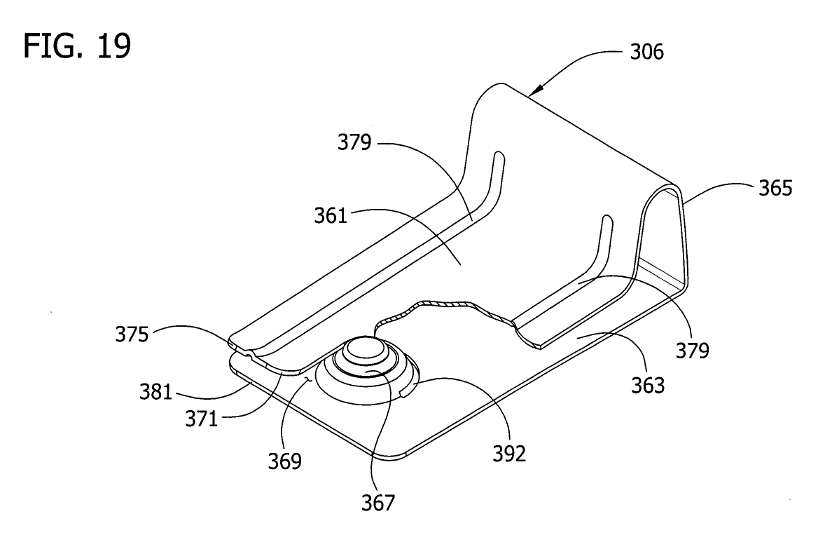

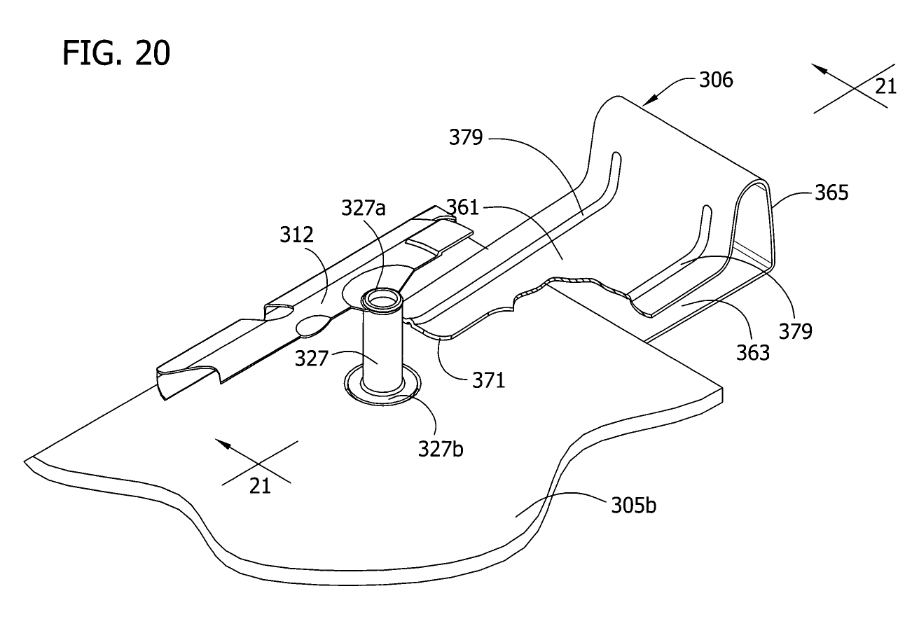

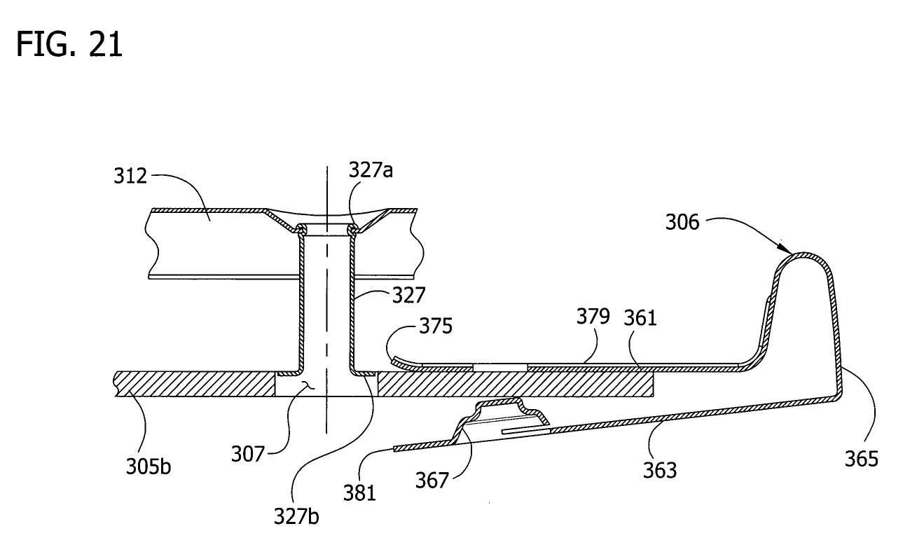

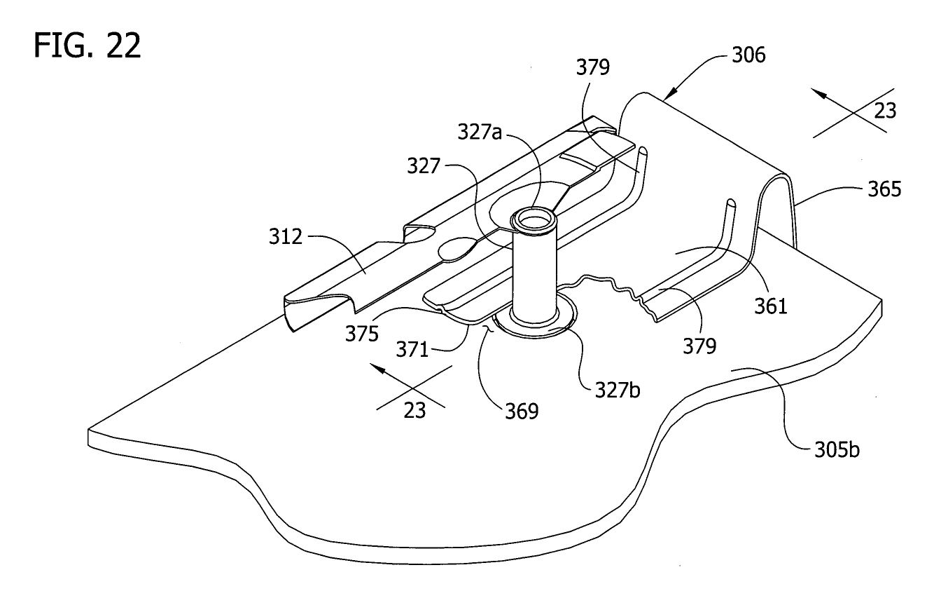

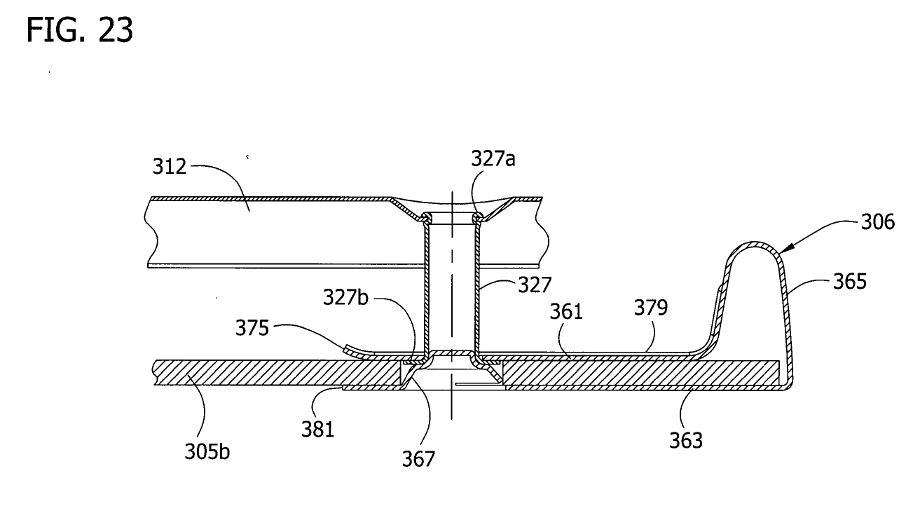

FIGS. 13-15 show a configuration of a clip 106 substantially similar to the previous described clip 6 except that a recess 190 is located adjacent a slot 169 in a first portion 161 of the clip. The recess 190 is sized and shaped for cooperating with a nub 167 to secure a flange 127b of a mounting post 127 in an aperture 107 in a cover 105. The recess 190 (as best seen in FIG. 15) extends down into the aperture 107 to clamp the flange 127b against the nub 167. As a result, this configuration supports the flange 127b of the mounting post 127 about midway through the cover aperture 107. Corresponding parts are indicated by the same reference numbers used in FIGS. 1-12 plus “100”. FIGS. 16-18 show another configuration of a clip 206 substantially similar to the clip of FIGS. 1-12. However, the ridge 77 adjacent the slot 69 of the clip 6 of FIGS. 1-12 is not present in this configuration. In this configuration, as best shown in FIG. 17, a closed bottom end 273 of a slot 269 engages a mounting post 227 when the clip 206 is positioned on a cover 205. Parts corresponding to those in FIGS. 1-12 are indicated by the same reference numbers plus “200”. FIGS. 19-23 show yet another configuration of a clip 306 substantially similar to the clip 6 of FIGS. 16-18. In this configuration, however, a slit 392 is located along adjacent a nub 67 located on a second portion 363 of the clip 306 for allowing the nub to deflect relative to the second portion as it is being slid over an exterior surface of a cover 305 (FIG. 21). Parts corresponding to those in FIGS. 1-12 are indicated by the same reference numbers plus “300”.

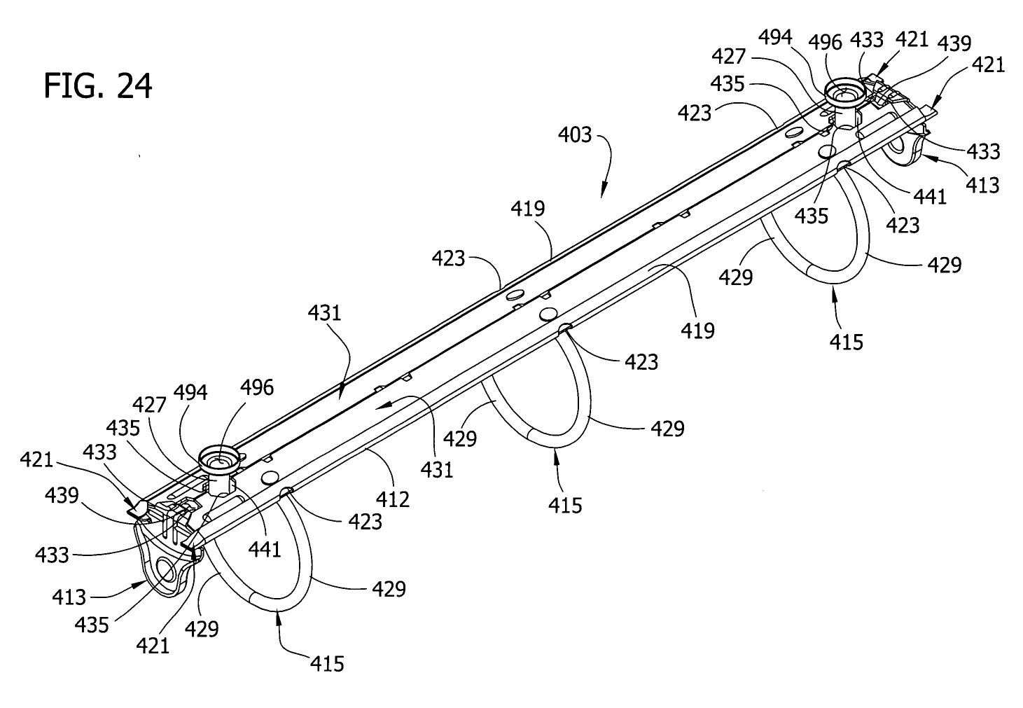

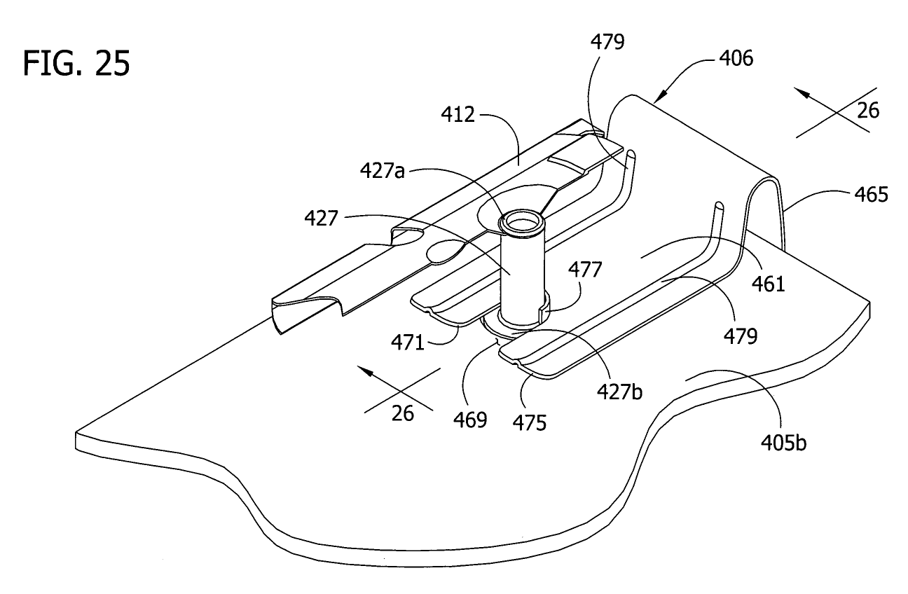

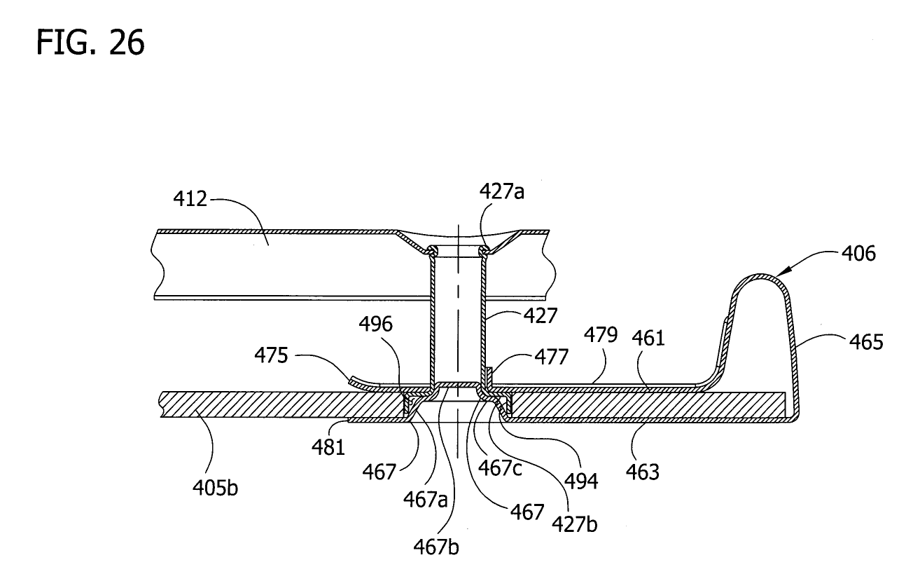

FIGS. 24-26 show another configuration of a ring binder mechanism 403 that is similar to the ring binder mechanism 3 shown in FIGS. 1-12 except the ring binder mechanism in this configuration includes a mounting post 427 having a rim 494 extending axially outwardly from a flange 427b and defining a socket 496. As shown in FIG. 26, the rim 494 is sized and shaped for placement adjacent a wall defining an aperture 407 in the cover 405 and the socket 496 is sized and shaped for receiving a portion of a nub 467. The rim 494 may engage the wall of the aperture 407 to help locate the ring binder mechanism 403.

Components of the mechanism of the present invention are made of a suitable rigid material, such as metal (e.g., steel). But mechanisms made of a non-metallic material, specifically including plastic, do not depart from the scope of this invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and other orientational terms is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A ring binder mechanism capable of mounting on a substrate, the ring binder mechanism comprising:
a housing;
at least one ring supported by the housing for mounting loose leaf paper;
at least one connector member extending outwardly from the housing; and
at least one clip for securing the connector member to a substrate, the clip being sized and shaped to slide onto the substrate and engage the connector member for securing the clip to the substrate and securing the connector member to the substrate.

2. A ring binder mechanism as set forth in claim 1 wherein the clip comprises a first portion and a second portion, the first and second portions being adapted to squeeze the connector member and the substrate together thereby securing the ring binder mechanism to the substrate.

3. The ring binder mechanism as set forth in claim 2 wherein the first and second portions define generally flat opposing surfaces resiliently biased toward one another when the clip is received on the substrate and engaging the connector member to secure the connector member to the substrate.

4. The ring binder mechanism as set forth in claim 3 wherein the first and second portions of the clip are formed from a single-piece of material.

5. The ring binder mechanism as set forth in claim 2 wherein the clip further comprises an intermediate portion connecting the first and second portions, the intermediate portion being shaped to yieldably resist movement of the first and second portions with respect to one another.

6. The ring binder mechanism as set forth in claim 5 wherein the intermediate portion is shaped to define a grip for gripping the clip.

7. The ring binder mechanism as set forth in claim 6 wherein the first and second portions lie generally in parallel planes, the intermediate portion extending from the second portion past the plane of the first portion and thence back to the first portion.

8. The ring binder mechanism as set forth in claim 1 wherein the connector member of the ring binder mechanism comprises a mounting post and a flange at the end of the post.

9. The ring binder mechanism as set forth in claim 8 wherein the first portion of the clip includes a slot for receiving the mounting post, the flange being disposed between the first and second portions of the clip when the clip is received on the substrate and engaging the connector member to secure the ring binder mechanism to the substrate.

10. The ring binder mechanism as set forth in claim 9 further comprising a ridge located generally at a closed bottom end of the slot, the ridge being shaped and arranged for engagement with the connector member.

11. The ring binder mechanism as set forth in claim 9 wherein the second portion of the clip includes a seat for receiving the flange of the connector member.

12. The ring binder mechanism as set forth in claim 11 wherein the mounting post has an interior space and an open end, and the seat has a nub for insertion through the open end into the interior space of the mounting post.

13. The ring binder mechanism as set forth in claim 11 wherein the first portion of the clip includes a recess, the recess and the seat being shaped and arranged for cooperating to secure the flange of the mounting post.

14. The ring binder mechanism as set forth in claim 11 wherein the second portion has a slit adjacent to the seat.

15. The ring binder mechanism as set forth in claim 9 wherein the first portion of the clip includes spaced apart ribs extending generally lengthwise of the first portion on opposite sides of the slot.

16. The ring binder mechanism as set forth in claim 8 wherein the connector member further comprises a rim extending axially outwardly from the flange and defining a socket.

17. The ring binder mechanism as set forth in claim 1 wherein the first portion of the clip includes a free outer edge, the first portion being bent upward away from the second portion adjacent the outer edge thereby to facilitate sliding the clip onto the substrate.

18. The ring binder mechanism as set forth in claim 1 in combination with a cover defining the substrate.

19. The ring binder mechanism as set forth in claim 18 wherein the cover comprises a front panel, a back panel and a spine, the front and back panels being hingedly attached to the spine so that the panels are movable to selectively cover or expose loose leaf pages retained by the ring binder mechanism.

20. The combination as set forth in claim 18 wherein the cover includes at least one opening for receiving a portion of the clip.

21. A ring binder comprising:
a ring binder mechanism including a housing having at least one ring for mounting loose leaf paper, and at least two connector members extending outwardly from the housing;
a cover including a front panel, a back panel and a spine, the front and back panels being hingedly attached to the spine so that the panels are movable to selectively cover or expose loose leaf pages retained by the ring binder mechanism; and
a clip for each connector member to secure the connector member to the cover, each clip extending around a respective edge of the cover and engaging a respective one of the connector members for securing the connector member to the cover.

22. A method of attaching a ring binder mechanism to a cover, the ring binder mechanism comprising at least one ring for mounting loose leaf paper thereon and at least one connector member extending outwardly from the housing, the method comprising:
arranging the ring binder mechanism and cover together in a predetermined orientation; and
sliding a clip onto an edge of the cover so that the clip engages the connector member and cover and secures the connector member and ring binder mechanism to the cover.

23. The method as set forth in claim 22 wherein arranging the ring binder mechanism and cover includes inserting a portion of the connector member into an opening in the cover.

24. The method as set forth in claim 23 further comprising engaging an interior surface of the cover with a first portion of the clip and engaging an exterior surface of the cover with a second portion.

25. The method as set forth in claim 22 further comprising sliding another clip onto another edge of the cover so that said other clip engages another connector member and the cover and secures said other connector member to the cover.
